(19) United States
(12) Patent Application Publication
(10) Pub. No.: US 2023/0240179 A1
(43) Pub. Date: Aug. 3, 2023

(54) AGRICULTURAL HEADER FLOAT ARM SYSTEM

(71) Applicant: DEERE & COMPANY, MOLINE, IL (US)

(72) Inventors: JOSHUA R. PIERSON, BETTENDORF, IA (US); MICHAEL L. VANDEVEN, LECLAIRE, IA (US); PETER T. SWANSON, HAYWARD, WI (US); ALEX A. BRIMEYER, BETTENDORF, IA (US); DANIEL S. HOFFMAN, Bettendorf, IA (US)

(21) Appl. No.: 17/649,819

(22) Filed: Feb. 3, 2022

(51) Int. Cl. A01D 34/28; A01D 34/04

(52) U.S. Cl. CPC A01D 34/283; A01D 34/04

(57) ABSTRACT

Apparatuses and agricultural implements are directed to maintaining engagement of float arms of an agricultural implement with a ground surface, maintaining a consistent load distribution to the ground, and maintaining a height of a cutterbar of the agricultural implement at a selected distance of the ground. An agricultural implement may include a frame configured to couple to an agricultural vehicle, a float arm pivotably coupled to the frame, a cutterbar coupled to float arm, and a biasing component disposed between the float arm and the frame that biases the float arm away from the frame.

### FIELD OF THE DISCLOSURE

The present disclosure relates generally to agricultural headers and, more particularly, to agricultural draper headers.

### BACKGROUND OF THE DISCLOSURE

Agricultural harvesters use a variety of implements to gather crops. Some implements include leading-edge knives, also referred to as a cutterbar, that severs crop material from the ground. The severed crop material is transported, such as with the use of conveyors, to a center region of the implement. From there, the cut crop material is conveyed into the harvesters where the cut crop material is further processed by separating grain from unwanted crop material (typically called “material other than grain” or “MOG”).

### SUMMARY OF THE DISCLOSURE

A first aspect of the present disclosure is directed to an agricultural implement. The agricultural implement may include a frame configured to couple to an agricultural vehicle, a float arm pivotably coupled to the frame, a cutterbar coupled to float arm, and a biasing component disposed between the float arm and the frame that biases the float arm away from the frame.

A second aspect of the present disclosure is directed to a method of operating an agricultural implement that includes a frame, a plurality of float arms pivotably coupled to the frame, a cutterbar coupled to distal ends of the float arms, and biasing components disposed between the plurality of float arms and the frame. The method may include distributing a weight of the header onto the ground via a plurality of float arms, imparting a separating force that biases the float arms away from the frame, traversing the ground with the agricultural implement, and biasing, with the biasing components, the float arms away from the frame and towards the ground so that the cutterbar follows a contour of the ground as the agricultural implement is moved along the ground.

Another aspect of the present disclosure is directed to an agricultural machine moveable along the ground for harvesting crop. The agricultural machine may include an agricultural vehicle and an agricultural implement coupled to the agricultural vehicle. The agricultural implement may include a frame coupled to the agricultural vehicle; a plurality of float arms pivotably coupled to the frame, at least a portion of the weight of the agricultural implement imparted to the ground via the plurality of float arms; a cutterbar coupled to distal ends of the float arms; and a biasing component disposed between each of float arms and the frame that biases the float arms away from the frame.

The various aspects may include one or more of the following features. An attachment frame may be coupled to the frame. A center section may be included, and a wing may extend laterally from the center section. The wing may be pivotably coupled to the center section. The float arm may include a plurality of float arms. The biasing component may include a plurality of biasing components, and each of the plurality of biasing components may be associated with a corresponding float arm of the plurality of float arms and may be disposed between the frame and the corresponding float arm. The biasing component may include a spring. The spring may include a coil spring or a torsional spring. The spring may be a compression spring or a tension spring. The biasing component may include a fluidic cylinder. The fluidic cylinder may include a pneumatic cylinder or a hydraulic cylinder. The biasing force applied by the biasing component may be adjustable. The biasing force may be adjustable in response to a user input.

The various aspects may include one or more of the following features. An attachment frame may be disposed between the frame of the agricultural implement and the agricultural vehicle.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a side view of an example agricultural vehicle, according to some implementations of the present disclosure.

FIG. 2 is a top view of the agricultural vehicle of FIG. 1.

FIG. 3 is an oblique view of an example header frame section, according to some implementations of the present disclosure.

FIG. 4 is a side view of the header frame section of FIG. 3.

FIG. 5 is a schematic view depicting a first exemplary roll center of the frame section of FIG. 3 positioned at ground level.

FIG. 6 is a schematic view depicting a second exemplary roll center of the frame section of FIG. 3 positioned below ground level.

FIG. 7 is a detailed side view of a portion of an example agricultural header, according to some implementations of the present disclosure.

FIG. 8 a detail view of the agricultural header of FIG. 7.

FIG. 9 is a detailed side view of a portion of another example agricultural header, according to some implementations of the present disclosure.

FIG. 10 is a detail view of the example float arm shown in FIG. 9.

FIG. 11 is a side view of another example agricultural header, according to some implementations of the present disclosure.

FIG. 12 is a schematic view showing a front view of an example agricultural header that omits biasing components disposed between frame and float arms.

FIG. 13 is a schematic view showing a front view of an example agricultural header that includes biasing components disposed between frame and float arms, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Words of orientation, such as “up,” “down,” “top,” “bottom,” “above,” “below,” “leading,” “trailing,” “front,” “back,” “forward,” and “rearward” that are used in the context of the illustrated examples are used as would be understood by one skilled in the art and are not intended to be limiting to the disclosure. For example, for a particular type of vehicle or implement in a conventional configuration and orientation, one skilled in the art would understand these terms as the terms apply to the particular vehicle or implement.

For example, as used herein, with respect to a work vehicle, unless otherwise defined or limited, the term “forward” (and the like) corresponds to a forward direction of travel of the work vehicle over the ground during normal operation of the work vehicle. Likewise, the term “rearward” (and the like) corresponds to a direction opposite the forward direction of travel of the work vehicle.

Also as used herein, with respect to an agricultural implement or components thereof, unless otherwise defined or limited, the term “leading” (and the like) indicates a direction of travel of the agricultural implement when viewed in a conventional orientation on flat ground during normal operation (e.g., the forward direction of travel of a work vehicle transporting an implement). Similarly, the term “trailing” (and the like) indicates a direction that is opposite the leading direction. A conventional orientation represents a work vehicle being oriented such that normal operation of the work vehicle can be performed. For example, a conventional orientation may involve having the tracks or wheels of the vehicle contacting the ground in a manner that allows the work vehicle to function as intended.

The present disclosure is directed to agricultural implements, such as agricultural headers, having float arms that are biased towards the ground (i.e., downwardly) when the agricultural headers are in a conventional orientation relative to the ground. Agricultural headers are used to harvest crops and include float arms biased in this manner to provide improved following of changing topography of the ground. As such, a cutterbar attached to the float arms, such as at distal ends of the float arms, has improved following of the shape of the ground surface, which, in turn, provides for improved crop harvesting. With the cutterbar having an improved ground following capability, a location above the ground at which crops are severed by the cutterbar has better uniformity. As such, more of the crops are captured and the stalk stubble remaining in the field has a more consistent height above the ground. Thus, harvesting is improved.

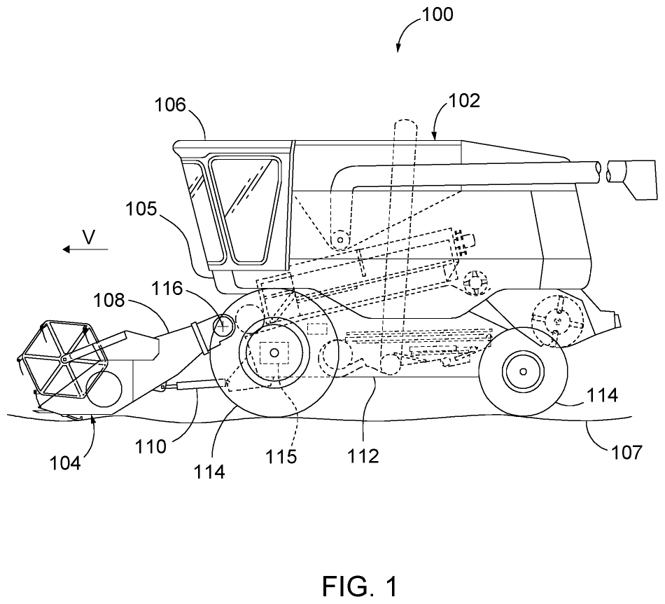

FIG. 1 is a side view of an example agricultural work vehicle 100 that includes a combine harvester 102 and an agricultural header 104 supported at the front end 105 of the combine harvester 102. The combine harvester 102 includes an operator cabin 106 that contains controls for piloting and operating the combine harvester 102. The combine harvester 102 includes a feederhouse 108 that is pivotally coupled at the front end 105 and one or more actuators 110 to support the feederhouse 108 and the agricultural header 104 above the ground 107. A chassis 112 of the combine harvester 102 is supported on wheels 114 that are driven by hydraulic motors 115 for travel over the ground 107. In other implementations, traction devices, other than wheels, such as tracks, are used to transport the combine harvester 102 along the ground 107.

In some implementations, the actuators 110 are double-acting hydraulic cylinders moveable between an extended position to a retracted position. When the actuators 110 are extended, the feederhouse 108 and the agricultural header 104 are raised upward, pivoting in a clockwise direction, as shown in the context of FIG. 1, about a pivot joint 116 that couples the feederhouse 108 to the chassis 112. When the actuators 110 are retracted, the forward end of the feederhouse 108 and the agricultural header 104 are lowered, pivoting counterclockwise, as shown in the context of FIG. 1, about the pivot joint 116. In other implementations, the actuators 110 are single-acting hydraulic cylinders. For example, in some instances in which actuators 110 are single-acting hydraulic cylinders, a weight of the feederhouse causes the actuators 110 to retract from an extended configuration.

Thus, by extending and retracting the actuators 110, the height of the feederhouse 108 and the agricultural header 104 can be varied. In the context of actuators 110 that are hydraulic, changing hydraulic fluid pressure in the actuators 110 changes an amount of downforce exerted by the agricultural header 104 against the ground 107. As hydraulic fluid pressure in the actuators increases, the downforce applied by the agricultural header 104 to the ground decreases. As the hydraulic fluid pressure in the actuators decreases, the downforce due to the weight of the agricultural header 104 increases. However, in other implementations, other types of actuators 110 are used. For example, in some instances, the actuators 110 can be electric or pneumatic devices, such as linear or rotary motors.

In operation, the agricultural header 104 severs crops from the ground 107 and conveys the severed crop material to the feederhouse 108, where the severed crop material enters the combine harvester 102 for processing. For example, in some instances, the combine harvester 102 separates grain from material other than grain (“MOG”), stores the clean grain, and ejects the MOG onto the ground 107.

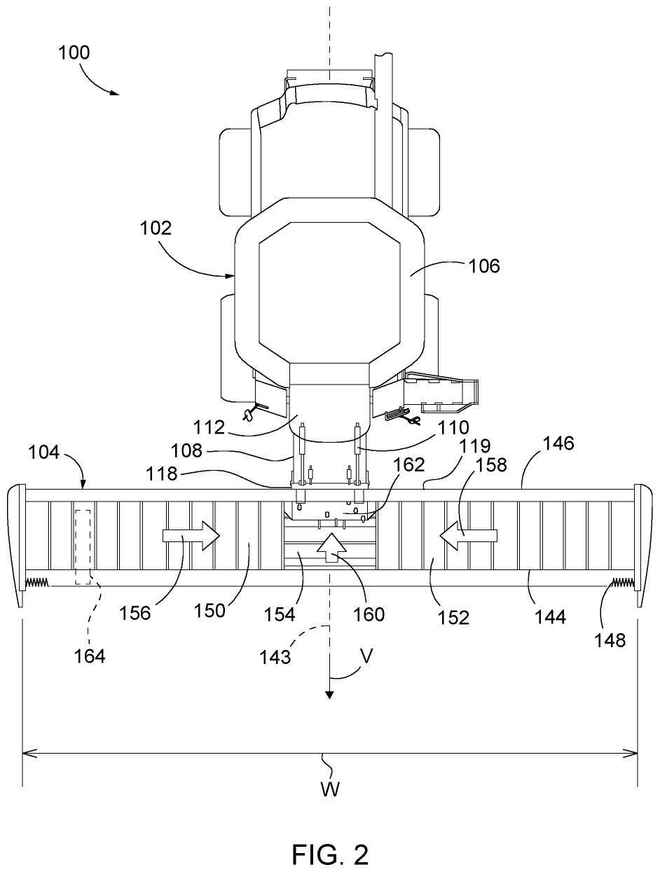

As shown in FIG. 2, the agricultural header 104 is supported on an end 118 of the feederhouse 108 and extends transversely to direction of travel, indicated by arrow 120, and to a central axis 143 of the combine harvester 102. The agricultural header 104 includes a frame 119 and a plurality of float arms 164 pivotably coupled to the frame 119. A central axis of the agricultural header 104 is aligned with the central axis 143 of the harvester vehicle 102. In the illustrated example, the agricultural header 104 is wider than the combine harvester 102. The agricultural header 104 includes a leading edge 144, a trailing edge 146, and a cutterbar 148 coupled to the leading edge 144. The cutterbar 148 extends the leading edge 144 and is operable to sever crops from the ground 107 as the combine harvester 102 moves along the ground 107.

The agricultural header 104 supports a first conveyor 150, a second conveyor 152, and a center conveyor 154 positioned between the first conveyor 150 and the second conveyor 152. In the illustrated embodiment, the center conveyor 154 is aligned with the central axis 143, and each of the conveyors 150, 152, 154 is configured as an endless belt conveyor. As the cutterbar 148 severs crops from the ground 107, the severed crop material falls onto the conveyors 150, 152, 154. The first conveyor 150 moves the severed crop material in a first direction 156 toward the center conveyor 154, and the second conveyor 152 moves the severed crop material in a second direction 158 toward the center conveyor 154. The center conveyor 154 moves the cut material in a third direction 160 past a feed drum 162 and towards the feederhouse 108.

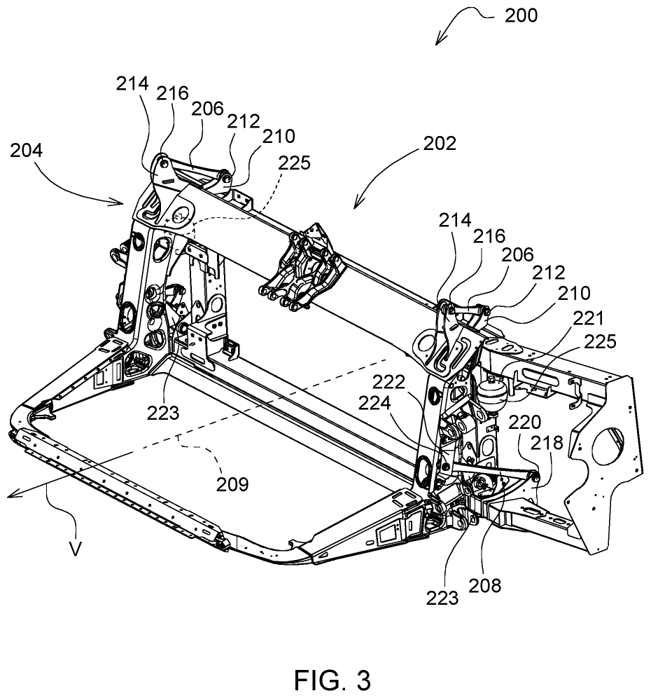

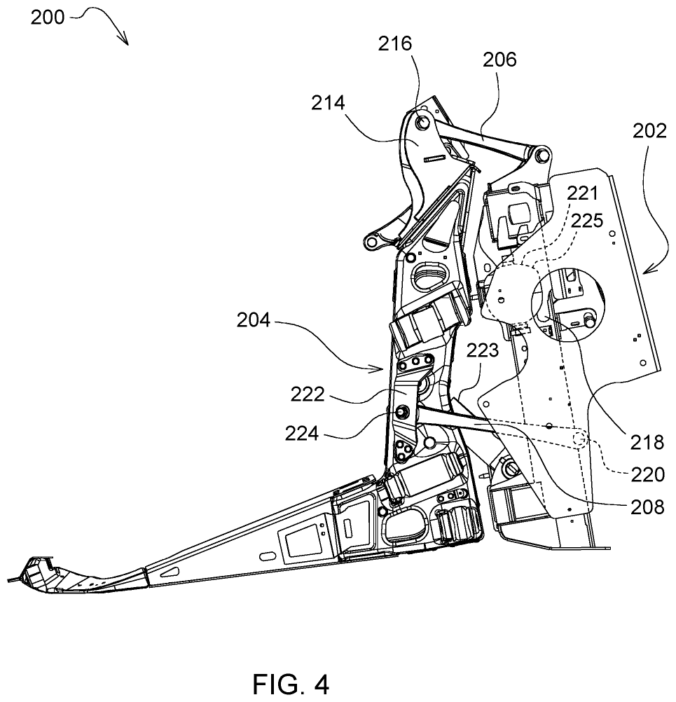

FIGS. 3 and 4 show an example header frame section 200 having a first frame portion (hereinafter referred to as attachment frame 202) and a second frame portion (hereinafter referred to as main frame 204). A header frame section, such as header frame section 200, is attached to or forms part of a header frame, such as frame 119, and is used to couple an agricultural header to an agricultural work vehicle. The attachment frame 202 connects to the feederhouse of an agricultural harvester, such as the feederhouse 108 of combine harvester 102, and the main frame 204 supports the remainder of an agricultural header, such as agricultural header 104, including, for example, a cutter bar (such as cutterbar 148) and conveyors (such as conveyors 150, 152, 154 shown in FIG. 2).

The main frame 204 is pivotally connected to the attachment frame 202 by a pair of upper control arms 206 and a pair of lower control arms 208. In some implementations, a single upper control arm is used. The upper control arms 206 are pivotally connected to a first bracket 210 on the attachment frame 202 at a first connection location 212 and pivotally connected to a second bracket 214 on the main frame 204 at a second connection location 216. The lower control arms 208 are pivotally connected to a third bracket 218 on the attachment frame 202 at a third connection location 220 and pivotally connected a fourth bracket 222 on the main frame 204 at a fourth connection location 224. The upper and lower control arms 206, 208 allow for height adjustment of the main frame 204 relative to the attachment frame 202 as the header frame section 200 and associated agricultural header traverses uneven ground. For example, the arrangement of the upper and lower control arms 206 and 208 allows the agricultural header 104 to move relative to the agricultural work machine 100 (e.g., movement in an upwards direction, in a downwards direction, and in rotational direction about an axis oriented similarly to the chassis axis 209). More particularly, the upper and lower control arms provide for a position and orientation change of the main frame 204 relative to the attachment frame 202, such as in response to bumps experienced by a combine harvester carrying the header frame section 200, such as combine harvester 102, as the combine harvester travels over the ground. The position and orientation changes of the main frame 204 relative to the attachment frame 202 is provided in a passive manner.

A suspension system 221 couples the attachment frame 202 to the main frame 204. In the illustrated example, the suspension system 221 includes a pair of hydraulic cylinders 223 and associated hydraulic accumulators 225. For each pair, the hydraulic cylinder 223 is in fluid communication with the associated accumulator 225. In some implementations, a hydraulic pressure within the suspension system 221 is selectable, such as by an operator. An operator may select a fluid pressure within the hydraulic cylinders 223 and associated hydraulic accumulators 225 based, for example, on a ground condition. In some instances, a first pressure is selected for a hard ground condition, and a second pressure is selected for a soft ground condition. The first pressure may provide for a greater weight of the agricultural header to rest on the ground, while the second pressure may provide for a lesser weight of the agricultural header to rest on the ground.

The selected pressure defines an amount by which the main frame 204 is moved (e.g., raised) relative to the attachment frame 202. Further, in operation, the suspension system 221 facilitates vertical motion of the main frame 204 relative to the attachment frame 202 (for example, in the context of FIG. 1) as well as pivoting movement of the main frame 204 relative to the attachment frame 202, such as pivoting about the central axis 143 shown in FIG. 2. In some implementations, the suspension system 221 is passively actuated. The hydraulic pressure for each hydraulic cylinder 223 and associated accumulator 225 is set to a selected pressure. With the selected pressure implemented, the suspension system 221 operates passively, for example, to allow the header coupled to the main frame 204 to follow along a contour of the ground.

With the header frame section 200 connected to a combine harvester, such as combine harvester 102, the upper and lower control arms 206, 208 extend along an axial direction that is non-parallel to a chassis axis 209, which may be similar to the chassis axis 143 shown in FIG. 2. The upper control arms 206 are angled so that the upper control arms 206 diverge from the chassis axis 209 in the direction of travel V, with the first connection location 212 positioned closer to the chassis axis 209 than the second connection location 216. The lower control arms 208 are angled so that the lower control arms 208 converge toward the chassis axis 209 in the direction of travel V, with the third connection location 220 positioned further from the chassis axis 209 than the fourth connection location 224. In some instances, the upper control arms 206 extend along respective axes lying in a common plane, and the common plane may or may not be parallel with a plane containing the chassis axis 209 that is parallel with the ground, e.g., a horizontal plane. Similarly, in some instances, the lower control arms 208 extend along respective axes lying in a common plane, and the common plane may or may not be parallel with a plane containing the chassis axis 209 that is parallel with the ground, e.g., a horizontal plane.

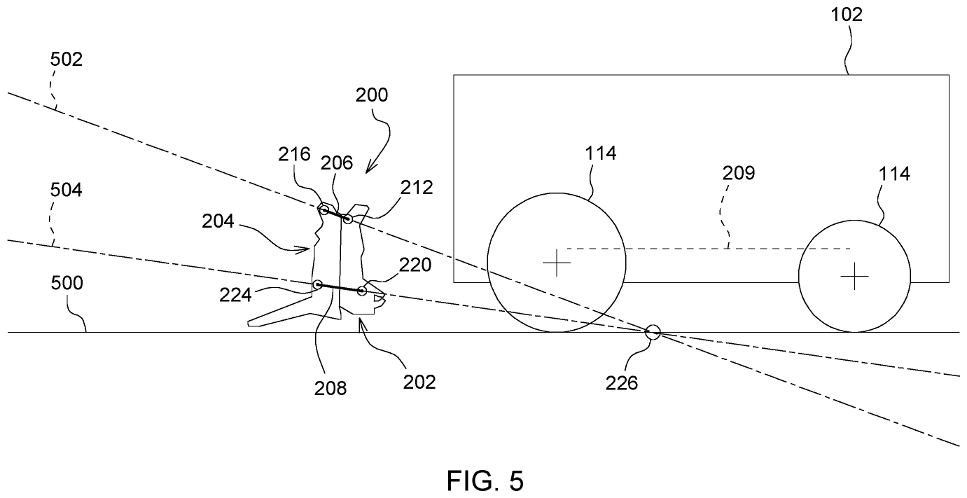

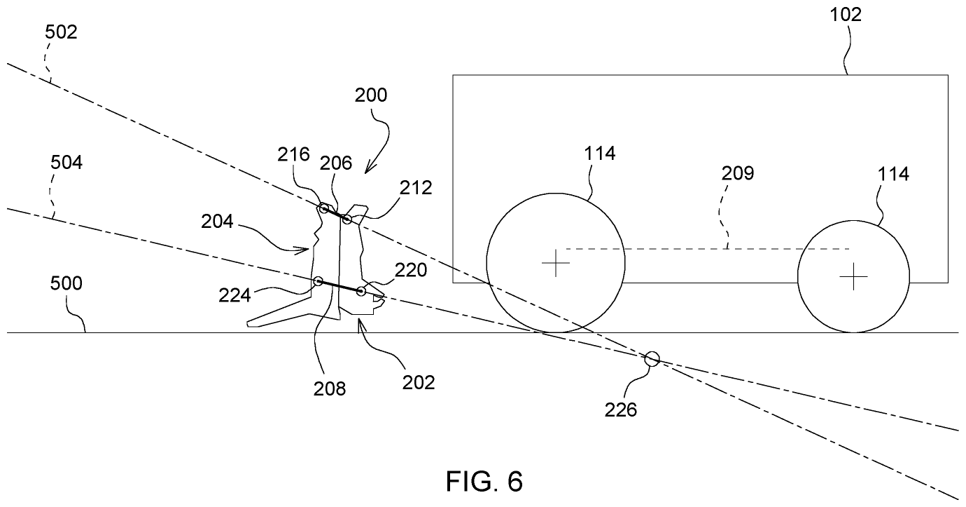

FIGS. 5 and 6 show a simplified, two-dimensional representation of the attachment frame 202, the main frame 204, the upper control arms 206, the lower control arms 208, and the first through fourth connection locations 212, 216, 220, 224 that define a roll center 226 for the attachment frame 202. FIG. 5 shows a first roll center 226 positioned at ground level 500, and FIG. 6 shows a second roll center 226 positioned below ground level 500. In this schematic view the attachment frame 202, the main frame 204, the upper control arms 206, and the lower control arms 208 form a four-bar linkage with the intersection of the control arms 206, 208 defining the roll center 226.

In the illustrated examples of FIGS. 5 and 6, the roll center 226 is defined at the intersection between an upper control arm axis 502 and a lower control arm axis 504. As discussed above, the control arms 206, 208 can extend non-parallel to the chassis axis 209 and in different planes. As shown, the chassis axis 209 is parallel with a plane defining the ground 500. Accordingly, the roll center 226 is determined by a planar or two-dimensional representation of the upper and lower control arm axes 502, 504. The upper control arm axis 502 is defined by an axis that extends through the first and second connection locations 212, 216 viewed in a single plane, in this case corresponding to a plane defining a side view of the header frame section 200. The lower control arm axis 504 is defined by an axis that extend through the third and fourth connection locations 220, 224 viewed in the single plane defined by FIG. 5.

FIG. 5 shows an example in which the upper control arm axis 502 and the lower control arm axis 504 intersect at the ground level 500, thereby creating a roll center 226 at the ground level 500. FIG. 6 shows an example in which the upper control arm axis 502 and the lower control arm axis 504 intersect below the ground level 500, therefore creating a roll center 226 below ground level 500. Because the ground is not typically flat (as shown in FIG. 1), the term ground level can mean ground level in the ordinary use of the term and also as a plane defined by the lower points of the front and back wheels 114 or other ground engaging members such as tracks. As shown in FIGS. 5 and 6, both roll centers 126 are positioned below the combine harvester 102 (illustrated schematically) and also between the wheels 114.

As mentioned, when an agricultural work vehicle (such as agricultural work vehicle 100) is traveling, a height (e.g., topography) of the ground can vary. Changes in topography, particularly abrupt changes, can cause engagement of an agricultural header (such as agricultural header 104 and 200) with the ground. Striking the ground creates a draft force that can increase the downward load on a main frame (such as main frame 204) and dislodge a normal position of a cutterbar of the agricultural header (such as cutterbar 148), causing the cutterbar to dig into the ground rather than cutting crops at a desired location about ground level. When this happens repeatedly, the cutter bar can become damaged or clogged with debris. When clogged with debris, an operator will have to stop the operation of the agricultural work vehicle to clear the debris. By positioning the roll center of the agricultural header at or below ground level, the draft forces acting on the agricultural header operates to lift the cutterbar. As a result, the cutterbar is capable of riding above the ground and engaging with crops in a desired manner (e.g., at a desired height above the ground) rather than being driven into the ground.

Inclusion of an attachment frame, such as attachment frame 202, operates to decouple movement of the agricultural work vehicle, such as agricultural work vehicle 100, from an agricultural header, such as agricultural header 104. The movement of the agricultural work machine includes movement caused by changes in the ground surface, e.g., changes in topography. These changes in the ground surface, when transmitted to an agricultural header lacking an attachment frame, can cause undesirable movements of the agricultural header that can cause the agricultural header to contact the ground. The use of the attachment frame provides for reduced movement transmittal from the agricultural work machine to the agricultural header and, consequently, improved terrain following and harvesting performance. Further, without an attachment frame, there is an increased risk of the header contacting the ground with excessive force or be positioned at a height above a desired cut height. The attachment frame also facilitate transfer of the weight of the agricultural header to and from the agricultural work machine. A pressure in the actuators coupling the attachment frame and the main frame can be altered to control an amount of weight of the agricultural header transferred to the agricultural work machine, even without raising or lowering the header by pivoting of a feederhouse, such as feederhouse 108.

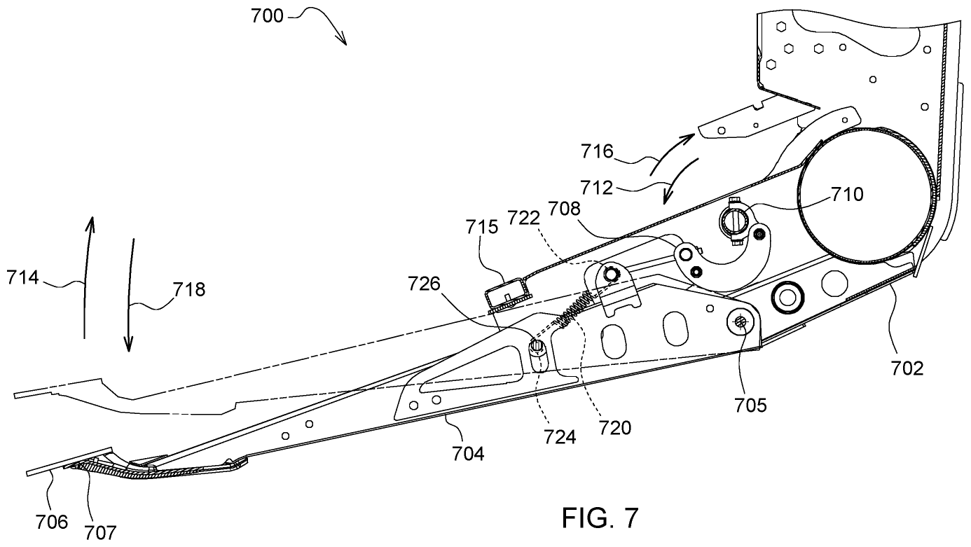

FIG. 7 is a detailed side view of a portion of an agricultural header 700. The agricultural header 700 may be similar to agricultural headers 104 and 200. The header 700 includes a frame 702 and a plurality of float arms 704 pivotably connected to the frame 702 along pivot axis 705. The float arms 704 are laterally distributed along a width of the header, as indicated by width W in FIG. 2. The float arms 704 extend in a longitudinal direction. An orientation of an example float arm 164 is shown in FIG. 2, wherein an orientation of float arm 164 generally aligns with central axis 143.

The agricultural header 700 also includes a cutterbar 706 that extends laterally therealong and is coupled to the float arms 704, such as at distal ends 707 thereof. The header 700 also includes a lockout system 708 that operates to move the float arms 704 and cutterbar 706 between a rigid configuration and a flexible configuration. In some implementations, the lockout system 708 is similar to the lockout system described in U.S. Patent Application Publication No. 2021/0368681, the entirety of which is incorporated herein by reference. The lockout system 708 includes a lockout shaft 710 that extends along the width W of the agricultural header 700. Rotation of lockout shaft 710 in a direction of arrow 712 causes the float arms 704 to rotate upwards in the direction of arrow 714 and into a locked configuration. In some implementations, the float arms 704 engage a portion 715 of the frame 702 when placed in the locked configuration. Rotation of the lockout shaft 710 in the direction of arrow 716, opposite the direction of arrow 712, causes the float arms to rotate in the direction of arrow 718, opposite the direction of arrow 714, placing the float arms 704 in the unlocked configuration. In the unlocked configuration, the float arms 704 are able to freely pivot about pivot axis 705, thus, allowing the float arms 704 to move in conformance with changes in the topography of the ground. Also, in the unlocked configuration, the float arms 704 are able to pivot about the pivot axis 705 independent of each other.

The agricultural header 700 also includes biasing components 720 disposed between the float arms 704 and the frame 702. In some implementations, a biasing component 720 is disposed between each float arm 704 and the frame. In other implementations, a biasing component 720 is omitted between one or more of the float arms 704 and the frame 720. The biasing components 720 include, for example, a spring or a fluidic cylinder. For example, in some implementations, the biasing component 720 may be a coil spring or a torsion spring or another type of spring. In some implementations, the biasing component 720 may be a fluidic cylinder, such as a pneumatic cylinder or a hydraulic cylinder. In some implementations, a force applied the biasing component 720 is alterable. For example, in some instances, the biasing component 720 is a fluidic cylinder in which a fluidic pressure is alterable to alter a force applied between the float arm 704 and the frame 702. More generally, the biasing component 720 includes any object that is operable to impart a biasing force between the float arms 704 and the frame 702.

In the illustrated example of FIG. 5, the biasing component 720 is a coil spring in which a first end 722 is coupled to float arm 702 and a second end 724 is coupled to the frame 702, such as at a pin 726. In this example, the biasing component 720 is a tension spring that imparts a force to the float arm 704 that biases the float arm 704 to pivot about the pivot axis 705 in the direction of arrow 718. Thus, although the float arms 704 are permitted to freely pivot about the pivot axis 705 when in the unlocked configuration, the biasing component 720 imparts a force the operates to separate the float arms 704 from the frame and pivot the float arms 720 in the direction of arrow 718.

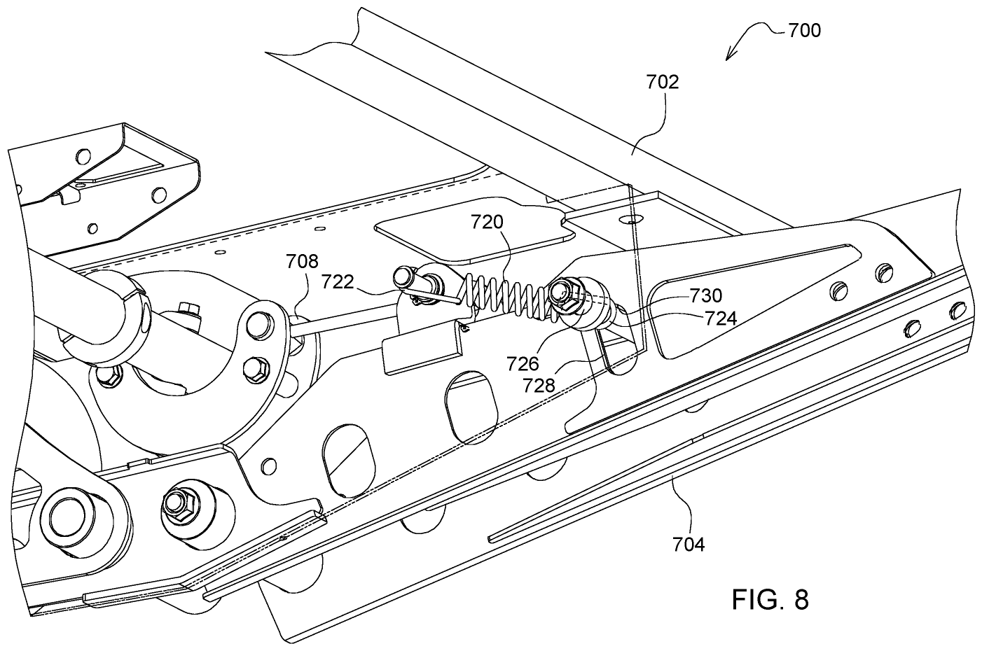

FIG. 8 is a detail view of the agricultural header 700 showing the arrangement of the biasing component 720 with respect to the frame 702 and the float arm 704. In this example, the pin 726 extends from the frame 702 and into a slot 728 formed in the float arm 704. Engagement of the pin 726 and a surface 730 of the slot 728 operates to limit an amount by which the float arm 704 is able to pivot about the pivot axis 705 in the direction of arrow 718.

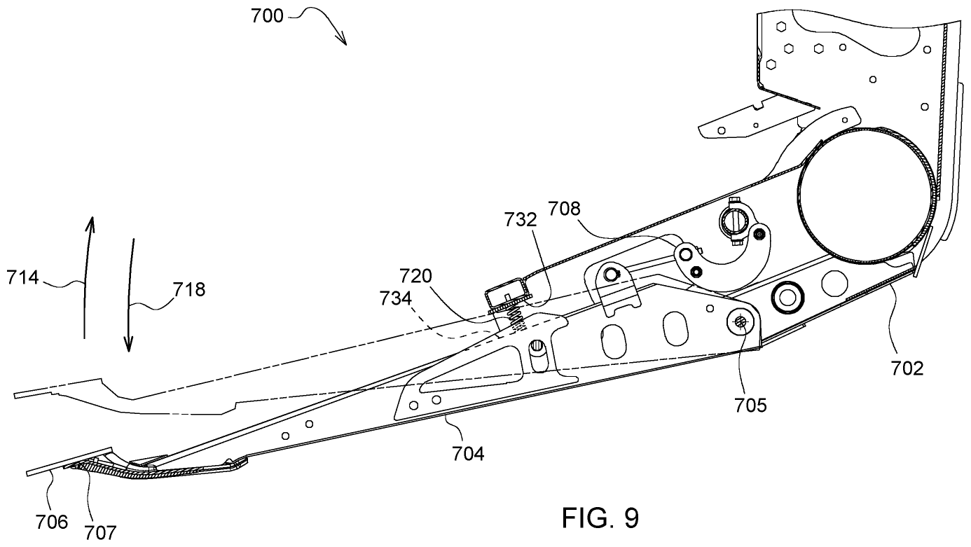

FIG. 9 shows another example of the header 700 in which the biasing component 720 is a compression spring. The compression spring is disposed between a portion 732 of the frame 200 and an upper surface 734 of the float arm 704. The compression spring imparts a force that operates to separate the float arm 704 from the frame 702 in the direction of arrow 718. As explained in the context of FIG. 7, above, interaction between the pin 726 and slot 728 into which the pin 726 is received operates to limit an amount by which the float arm 704 is able to pivot about the pivot axis 705 in the direction of arrow 718.

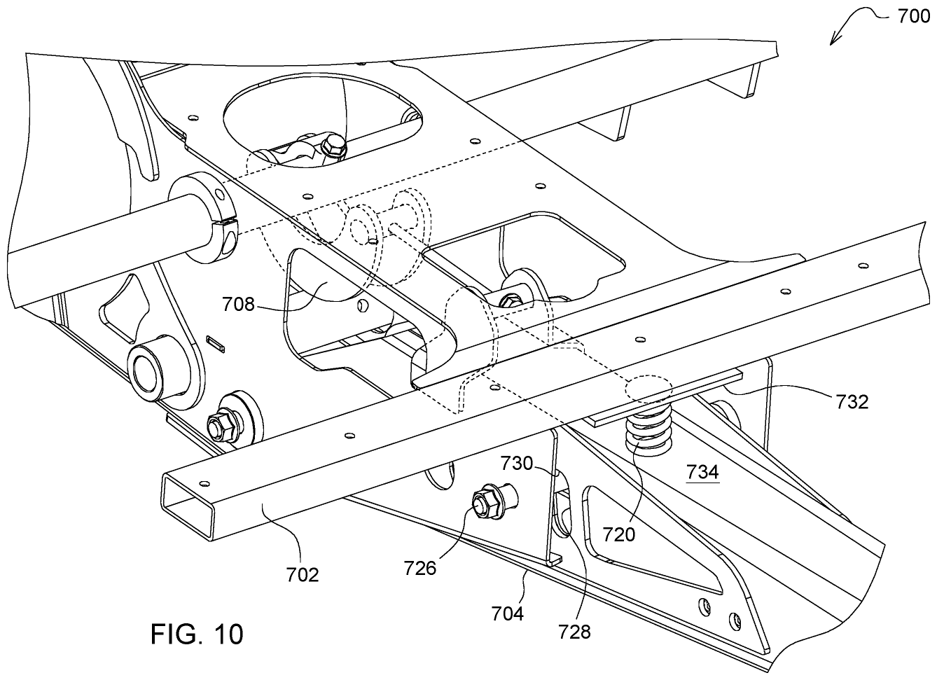

FIG. 10 is a detail view of the example float arm shown in FIG. 9 in which the biasing component 720 is a compression spring disposed between a surface 732 of the frame 702 and a surface 734 of the float arm 704.

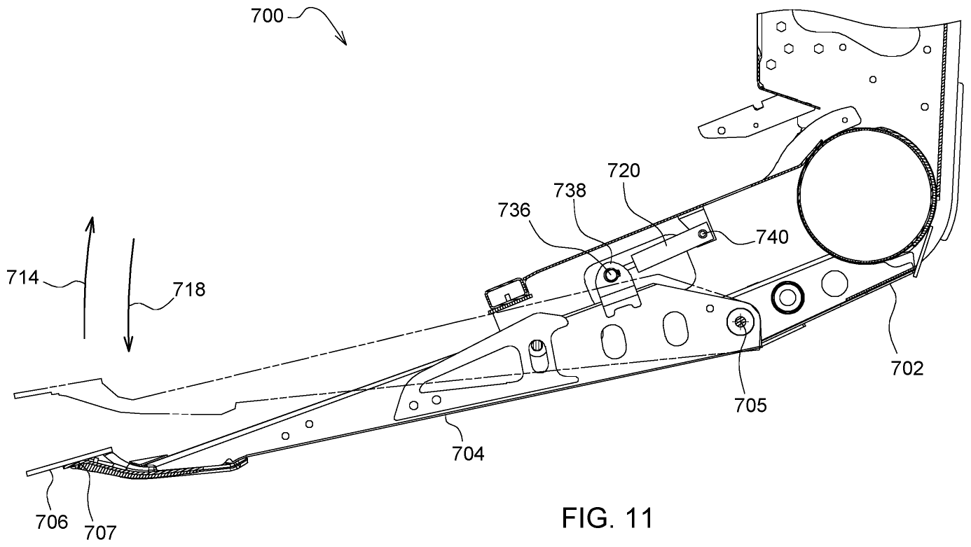

FIG. 11 illustrates another example of the agricultural header 700 in which a fluidic cylinder forms the biasing component 720. In this example, the fluidic cylinder replaces the lockout system 708. However, in other implementations, a lockout system, such as a lockout system similar to lockout system 708, is included. In this example, the fluidic cylinder is operable to extend and retract and, thus, does not merely operate as a spring. The biasing component 720 includes a first end 736 coupled to a protrusion 738 of the float arm 704 and a second end 740 coupled to the frame 702. In this example, the first and second ends 736 and 740 are pinned connections providing for relative rotation between the biasing component 720 and the float arm 704 and frame 702, respectively.

In the retracted configuration, as shown in FIG. 11, the float arm 704 is retracted, causing rotation of the float arm 704 about the pivot axis 705 in the direction of arrow 714, and locked into the locked configuration. When the fluidic cylinder is extended, the float arm is pivoted about the pivot axis 705 in the direction of arrow 718 and placed into the unlocked configuration. Further, in the extended position, a pressure applied by the fluid cylinder can be altered, such as by altering a fluidic pressure applied thereto to impart a selected level of downforce (i.e., separation force) applied to the float arm 704, thereby separating the float arm 704 from the frame 702. In operation with the fluidic cylinder in the extended condition, loading imparted to the float arm 704 tending to pivot the float arm 704 about the pivot axis 705 in the direction of arrow 714 that exceeds a selected amount overcomes the biasing force imparted by the fluidic cylinder, thereby allowing the float arm 704 to pivot upwards in the direction of arrow 714. In some implementations, an accumulator is coupled to the fluidic pressure of the fluidic cylinder, and a pressure of the accumulator is selected to define the force at which the fluidic cylinder will retract in response to loading applied to the float arm 704.

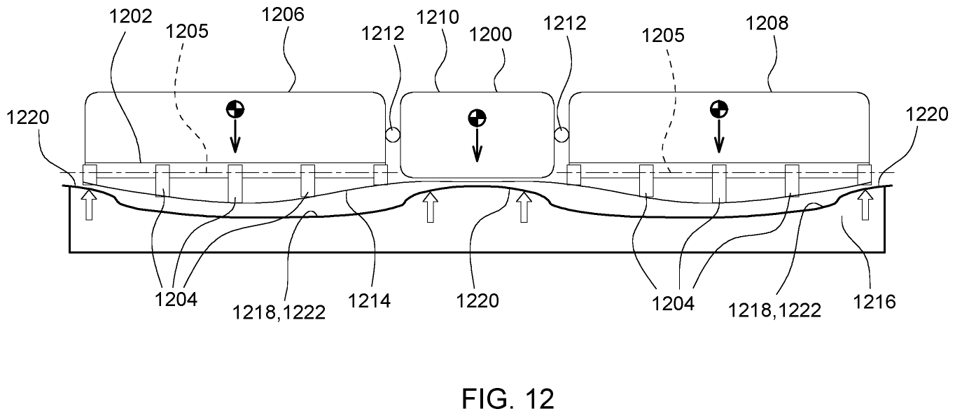

FIG. 12 is a schematic view showing a front view of an example agricultural header 1200 that omits biasing components disposed between frame 1202 and float arms 1204 pivotable about pivot axis 1205. In this example, the agricultural header 1200 has wings 1206 and 1208 that are pivotably coupled to a center section 1210 via pivots 1212. This wings 1206 and 1208 are able to pivot about the pivots 1212 in response to changing topography of the ground 1216. Without biasing components, movement of the float arms 1204 in an unlocked configuration (illustrated) is subject to the force of gravity and the rigidity of cutterbar 1214 coupled to the float arms 1204, such as at distal ends of the float arms 1204.

As illustrated in FIG. 12, the agricultural header 1200 experiences uneven ground 1216 in which ruts or recesses 1218 are formed between peaks 1220. As a result of the recesses 1218, the float arms 1204 located above the recesses 1218 pivot downwards towards the surface 1222 of the recesses 1218. However, due to the rigidity of the cutterbar 1214, an amount by which the float arms 1204 is able to pivot downwards towards the surface 1222 is limited. As a result, in some instances where the float arms are unable to pivot sufficiently to regain contact with the ground 1216, an amount of weight of the agricultural header 1200 normally transferred to the ground respectively by those float arms is transferred to the float arms that remain in contact with the ground 1216. As a result, a pressure applied to the ground 1216 by the remaining float arms 1204 increases. This increase in pressure can cause contact, such as gouging or pushing, between the cutterbar 1214 and the ground 1216. This contact can lead to damage to the cutterbar 1214, clogging of the cutterbar 1214, damage to the ground 1216, and severing of crop material at an undesirable location relative to the ground 1216.

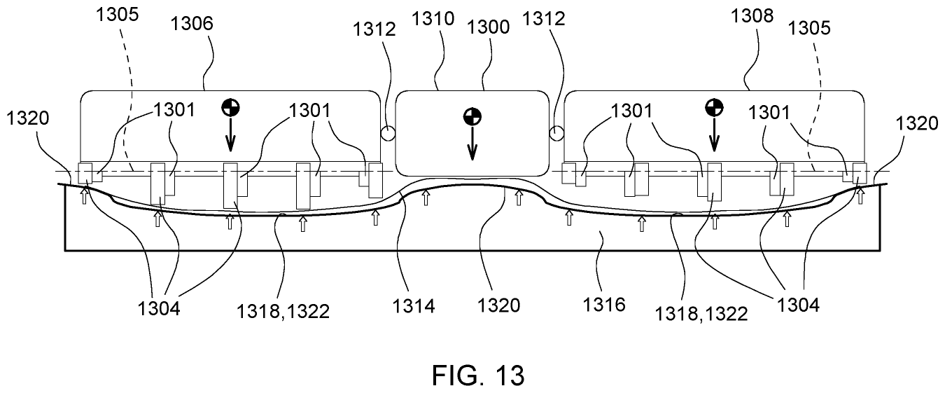

FIG. 13 is a schematic view similar to the one shown in FIG. 12 except that the agricultural header 1300 shown in FIG. 13 includes biasing components 1301 disposed between a frame 1302 and float arms 1304 pivotable about pivot axis 1305. The agricultural header 1300 includes wings 1306 and 1308 pivotably coupled to a center section 1310 via pivots 1312. This wings 1306 and 1308 are able to pivot about pivots 1312 in response to changing topography of the ground 1316.

As a result of the biasing force applied to the float arms 1304 by the biasing components 1301 when the float arms are in an unlocked position, the float arms 1304 more closely follow a contour of ground 1316. As shown, the biasing force imparted by the biasing components forces the float arms 1304 to remain in contact with surfaces 1322 of recesses 1318 formed between peaks 1320 of uneven ground 1316. The biasing force can be selected to overcome the rigidity associated with cutterbar 1314, providing for the float arms 1304 to maintain contact with the ground 1316. As a result, an improved weight distribution of the agricultural header 1300 is maintained via the float arms 1304. That is, by maintaining contact between an increased (or all) of the float arms, a reduced amount of weight of the agricultural header 1300 is carried by each float arm 1304. This results in a reduced risk of contact between the ground 1316 and cutterbar 1314 when the uneven ground 1316 is experienced, a risk of damage to the cutterbar 1314 due to a reduced chance of contact with the ground, and improved uniformity in location above the ground 1316 at which crops are severed by the cutterbar 1304.

The biasing components described herein can be applied to agricultural headers that include wings (as shown, for example, in FIG. 13). The wings provide for improved terrain following of the agricultural header and, as a result, the cutterbar. Consequently, improved cutting performance (e.g., consistent stalk stubble height) is achieved. The pivoting action of the wings, in combination with the improved terrain following of the float arms provided by the biasing components, further improves harvesting performance.

A benefit of an attachment frame is to decouple an amount of motion between the agricultural header and the agricultural work machine. As explained above, an attachment frame provides for reduced movement transmittal between an agricultural work machine and the agricultural header and, consequently, improved terrain following and harvesting performance. Thus, in addition to the improved terrain following provided by bias float arms, the addition of an attachment frame further improves terrain following and harvesting performance. The addition of pivotable wings further enhances ground following and harvesting performance.

However, biasing components as described herein are combinable with agricultural headers that lack wings or an attachment frame.

Without in any way limiting the scope, interpretation, or application of the claims appearing below, a technical effect of one or more of the example implementations disclosed herein is improved terrain following of float arms of an agricultural header. Another technical effect of one or more of the example implementations disclosed herein is improved weight distribution of an agricultural header as a result of improved terrain following of float arms of the agricultural header. Another technical effect of one or more of the example implementations disclosed herein is reduced risk of contact between a cutter bar of an agricultural header and the ground.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. An agricultural implement comprising:
a frame configured to couple to an agricultural vehicle;
a float arm pivotably coupled to the frame;
a cutterbar coupled to float arm; and
a biasing component disposed between the float arm and the frame that biases the float arm away from the frame.

2. The agricultural implement of claim 1, further comprising an attachment frame coupled to the frame.

3. The agricultural implement of claim 1, further comprising:
a center section; and
a wing extending laterally from the center section, the wing pivotably coupled to the center section.

4. The agricultural implement of claim 1, wherein the float arm comprises a plurality of float arms,
wherein the biasing component comprises a plurality of biasing components, and
wherein each of the plurality of biasing components is associated with a corresponding float arm of the plurality of float arms and is disposed between the frame and the corresponding float arm.

5. The agricultural implement of claim 1, wherein the biasing component comprises a spring.

6. The agricultural implement of claim 5, wherein the spring comprises a coil spring or a torsional spring.

7. The agricultural implement of claim 1, wherein the biasing component comprises a fluidic cylinder.

8. The agricultural implement of claim 7, wherein the fluidic cylinder comprises a pneumatic cylinder or a hydraulic cylinder.

9. The agricultural implement of claim 1, wherein a biasing force applied by the biasing component is adjustable.

10. The agricultural implement of claim 9, wherein the biasing force is adjustable in response to a user input.

11. A method of operating an agricultural implement that includes a frame, a plurality of float arms pivotably coupled to the frame, a cutterbar coupled to distal ends of the float arms, and biasing components disposed between the plurality of float arms and the frame, the method comprising:
distributing a weight of the agricultural implement onto the ground via a plurality of float arms;
imparting a separating force that biases the float arms away from the frame;
traversing the ground with the agricultural implement; and
biasing, with the biasing components, the float arms away from the frame and towards the ground so that the cutterbar follows a contour of the ground as the agricultural implement is moved along the ground.

12. The method of claim 11, wherein biasing, with the biasing components, the float arms away from the frame and towards the ground so that the cutterbar follows a contour of the ground as the agricultural implement is moved along the ground comprises extending one or more of the biasing components at a location along the agricultural implement where the ground forms a recess.

13. The method of claim 11, wherein the biasing component comprises a spring.

14. The method of claim 13, wherein the spring comprises a coil spring or a torsional spring.

15. The method of claim 11, wherein the biasing component comprises a fluidic cylinder.

16. The method of claim 15, wherein the fluidic cylinder comprises a pneumatic cylinder or a hydraulic cylinder.

17. The method of claim 11, wherein the biasing force applied by the biasing component is adjustable.

18. The method of claim 11, further comprising adjusting a biasing force of the biasing components.

19. An agricultural machine moveable along the ground for harvesting crop, the agricultural machine comprising:
an agricultural vehicle;
an agricultural implement coupled to the agricultural vehicle, the agricultural implement comprising:
a frame coupled to the agricultural vehicle;
a plurality of float arms pivotably coupled to the frame, at least a portion of the weight of the agricultural implement imparted to the ground via the plurality of float arms;
a cutterbar coupled to distal ends of the float arms; and
a biasing component disposed between each of float arms and the frame that biases the float arms away from the frame.

20. The agricultural machine of claim 19, further comprising an attachment frame disposed between the frame of the agricultural implement and the agricultural vehicle.

21. The agricultural machine of claim 19, wherein the agricultural implement further comprises:
a center section; and
a wing portion laterally extending from and pivotably coupled to the center section.
